(19) United States
(12) Patent Application Publication
(10) Pub. No.: US 2026/0283259 A1
(43) Pub. Date: Sep. 24, 2026

(54) APPARATUS FOR AN AEROSOL GENERATING DEVICE

(71) Applicant: Nicoventures Trading Limited, London (GB)

(72) Inventors: Martin HORROD, London (GB); Julian WHITE, London (GB); Victor Clavez Lopez, London (GB)

(21) Appl. No.: 19/685,748

(22) Filed: May 22, 2026

Related U.S. Application Data
(63) Continuation of application No. 17/596,315, filed on Jun. 25, 2020.

(30) Foreign Application Priority Data
Jun. 28, 2019 (GB) 1909377.2

(51) Int. Cl. A24F 40/53; A24F 40/465; A24F 40/51; A24F 40/57

(52) U.S. Cl. CPC A24F 40/53; A24F 40/465; A24F 40/51; A24F 40/57

(57) ABSTRACT

A method and apparatus is described including controlling a resonant circuit of an aerosol generating device, the resonant circuit having an inductive element for inductively heating a susceptor arrangement to heat an aerosol generating material to thereby generate an aerosol in a heating mode of operation; measuring a current flowing in the inductive element; and determining one or more characteristics of the aerosol generating device and/or the susceptor arrangement based on said measured current.

### PRIORITY CLAIM

The present application is a continuation of U.S. Application No. 17/596,315 filed Dec. 7, 2021, which is a National Phase entry of PCT Application No. PCT/GB2020/051545, filed Jun. 25, 2020, which claims priority from Great Britain Application No. 1909377.2, filed Jun. 28, 2019, each of which is hereby fully incorporated herein by reference.

### TECHNICAL FIELD

The present specification relates to an apparatus for an aerosol generating device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol generating substrate such as tobacco to form an aerosol by heating, but not burning, the substrate.

### SUMMARY

In a first aspect, this specification describes an apparatus for an aerosol generating device, the apparatus comprising: a resonant circuit (such as an LC resonant circuit) comprising an inductive element for inductively heating a susceptor arrangement to heat an aerosol generating material to thereby generate an aerosol in a heating mode of operation; a current sensor for measuring a current flowing in the inductive element; and a processor for determining one or more characteristics of one or more of the aerosol generating device the apparatus and the susceptor arrangement based (at least in part) on the measured current.

The one or more characteristics determined by the processor may include one or more of: the presence or absence of the susceptor arrangement; one or more fault conditions; or whether the measured current matches the current of a predefined susceptor arrangement.

The susceptor arrangement may be provided as part of a removable article. Furthermore, the one or more characteristics determined by the processor may include properties of said removable article. The properties of the removable article determined by the processor may include the presence or absence of the removable article.

Determining said one or more characteristics may include determining whether the measured current is consistent with the susceptor arrangement having a temperature above a first temperature threshold and/or below a second temperature threshold.

Some embodiments include a first switching arrangement (such as an H-bridge circuit) for enabling an alternating current to be generated from a DC voltage supply and flow through the inductive element to cause inductive heating of the susceptor arrangement in the heating mode of operation.

Some embodiments further include an impulse generation circuit for applying an impulse to the resonant circuit, wherein the applied impulse induces an impulse response between a capacitor and the inductive element of the resonant circuit, wherein the impulse response has a resonant frequency; and an output circuit for providing an output signal dependent on one or more properties of the impulse response. The output signal may be indicative of the resonant frequency of the pulse response. The output signal may be used to provide a temperature measurement of said inductive element.

In a second aspect, this specification describes a non-combustible aerosol generating device comprising an apparatus includes any of the features of the first aspect described above.

The aerosol generating device may be configured to receive a removable article comprising an aerosol generating material. Further, the aerosol generating material may include an aerosol generating substrate and an aerosol forming material. The removable article may include the susceptor arrangement.

In a third aspect, this specification describes a method comprising: controlling a resonant circuit (e.g. an LC resonant circuit) of an aerosol generating device, the resonant circuit comprising an inductive element for inductively heating a susceptor arrangement to heat an aerosol generating material to thereby generate an aerosol in a heating mode of operation; measuring a current flowing in the inductive element (e.g. in a heating mode of operation); and determining one or more characteristics of the aerosol generating device and/or the susceptor arrangement based (at least in part) on the measured current.

The one or more characteristics determined by the processor may include one or more of: the presence or absence of the the susceptor arrangement; properties of the removable article; the presence or absence of the the removable article; one or more fault conditions; whether the measured current matches the current of a predefined susceptor arrangement; whether current is consistent with the susceptor having a temperature above a first temperature threshold and/or below a second temperature threshold; or whether the measured current matches the current of a genuine susceptor.

The method may further include applying an impulse to the resonant circuit, wherein the applied impulse induces an impulse response between a capacitor and the inductive element of the resonant circuit, wherein the impulse response has a resonant frequency; and generating an output signal dependent on one or more properties of the impulse response.

In a fourth aspect, this specification describes computer-readable instructions which, when executed by computing apparatus, cause the computing apparatus to perform any method as described with reference to the third aspect.

In a fifth aspect, this specification describes a kit of parts comprising an article for use in a non-combustible aerosol generating system, wherein the non-combustible aerosol generating system includes an apparatus including any of the features of the first aspect described above or an aerosol generating device including any of the features of the second aspect described above. The article may be a removable article comprising an aerosol generating material.

In a sixth aspect, this specification describes a computer program comprising instructions for causing an apparatus to perform at least the following: control a resonant circuit of an aerosol generating device, the resonant circuit comprising an inductive element for inductively heating a susceptor arrangement to heat an aerosol generating material to thereby generate an aerosol in a heating mode of operation; measure a current flowing in the inductive element; and determine one or more characteristics of the aerosol generating device and/or the susceptor arrangement based (at least in part) on the measured current.

### BRIEF DESCRIPTION OF THE DRAWINGS

Example embodiments will now be described, by way of example only, with reference to the following schematic drawings, in which:

FIGS. 1 and 2 are block diagrams of systems in accordance with an example embodiment;

FIG. 3 shows a non-combustible aerosol generating device in accordance with an example embodiment;

FIG. 4 is a view of a non-combustible aerosol generating device in accordance with an example embodiment;

FIG. 5 is a view of an article for use with a non-combustible aerosol generating device in accordance with an example embodiment;

FIG. 6 is a block diagram of a circuit in accordance with an example embodiment;

FIGS. 7, 8, and 9 are flow charts showing algorithms in accordance with example embodiments;

FIG. 10 shows plots demonstrating example uses of example embodiments;

FIG. 11 is a flow chart showing an algorithm in accordance with an example embodiment;

FIG. 12 is a block diagram of a circuit in accordance with an example embodiment;

FIG. 13 is a flow chart showing an algorithm in accordance with an example embodiment;

FIGS. 14 and 15 are plots demonstrating example uses of example embodiments;

FIG. 16 is a flow chart showing an algorithm in accordance with an example embodiment;

FIG. 17 is a plot showing an example use of the algorithm of FIG. 16;

FIGS. 18 and 19 are block diagrams of systems in accordance with example embodiments;

FIG. 20 is a flow chart showing an algorithm in accordance with an example embodiment;

FIG. 21 is a block diagram of a circuit switching arrangement in accordance with an example embodiment;

FIG. 22 is a block diagram of a circuit switching arrangement in accordance with an example embodiment; and

FIGS. 23 and 24 are flow charts showing algorithms in accordance with example embodiments.

### DETAILED DESCRIPTION

As used herein, the term “delivery system” is intended to encompass systems that deliver a substance to a user, and includes: combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material); non-combustible aerosol provision systems that release compounds from an aerosolizable material without combusting the aerosolizable material, such as electronic cigarettes, tobacco heating products, and hybrid systems to generate aerosol using a combination of aerosolizable materials; articles comprising aerosolizable material and configured to be used in one of these non-combustible aerosol provision systems; and aerosol-free delivery systems, such as lozenges, gums, patches, articles comprising inhalable powders, and smokeless tobacco products such as snus and snuff, which deliver a material to a user without forming an aerosol, wherein the material may or may not comprise nicotine.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system includes a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol generating device and an article for use with the non-combustible aerosol provision system. However, it is envisaged that articles which themselves comprise a means for powering an aerosol generating component may themselves form the non-combustible aerosol provision system.

In one embodiment, the non-combustible aerosol generating device may comprise a power source and a controller. The power source may be an electric power source or an exothermic power source. In one embodiment, the exothermic power source comprises includes a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol generating device may include an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurisation or electrostatic means.

In one embodiment, the aerosolizable material may include an active material, an aerosol forming material and optionally one or more functional materials. The active material may include nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception.

The aerosol forming material may include one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may include one or more of flavors, carriers, pH regulators, stabilizers, and/or antioxidants.

In one embodiment, the article for use with the non-combustible aerosol generating device may include aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

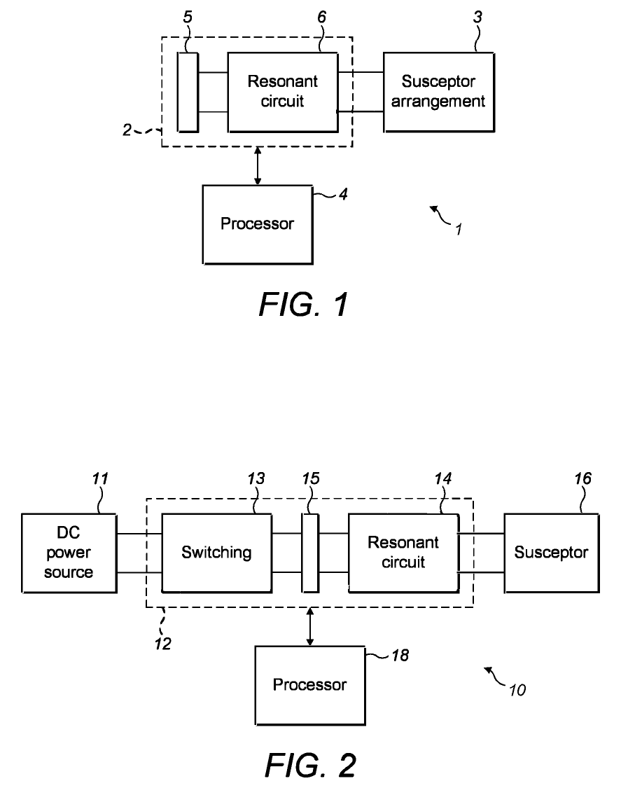

FIG. 1 is a block diagram of a system, indicated generally by the reference numeral 1, in accordance with an example embodiment. System 1 comprises a current sensor 5, a resonant circuit 6, a susceptor arrangement 3, and a processor 4.

The resonant circuit 6 may comprise a capacitor and one or more inductive elements for inductively heating the susceptor arrangement 3 to heat an aerosol generating material. Heating the aerosol generating material may thereby generate an aerosol.

The current sensor 5 may measure a current flowing in the one or more inductive elements of the resonant circuit 6. The resonant circuit 6 and the current sensor 5 may be coupled together in an inductive heating arrangement 2, and the inductive heating arrangement 2 may be coupled to the processor 4. The processor 4 may receive information regarding the measured current from the current sensor 5.

FIG. 2 is a block diagram of a system, indicated generally by the reference numeral 10, in accordance with an example embodiment. System 10 comprises a power source in the form of a direct current (DC) voltage supply 11, a switching arrangement 13, a resonant circuit 14, a current sensor 15, a susceptor arrangement 16, and a processor 18. The switching arrangement 13, the resonant circuit 14, and the current sensor 15 may be coupled together in an inductive heating arrangement 12.

The resonant circuit 14 (similar to the resonant circuit 6) may comprise a capacitor and one or more inductive elements for inductively heating the susceptor arrangement 16 to heat an aerosol generating material.

The switching arrangement 13 may enable an alternating current to be generated from the DC voltage supply 11. The alternating current may flow through the one or more inductive elements of the resonant circuit 14, and may cause the heating of the susceptor arrangement 16. The switching arrangement 13 may comprise a plurality of transistors. Example DC-AC converters include H-bridge or inverter circuits, examples of which are discussed below. It should be noted that the provision of a DC voltage supply 11 from which a pseudo AC signal is generated is not an essential feature; for example, a controllable AC supply or an AC-AC converter may be provided. Thus, an AC input could be provided (such as from a mains supply or from an inverter).

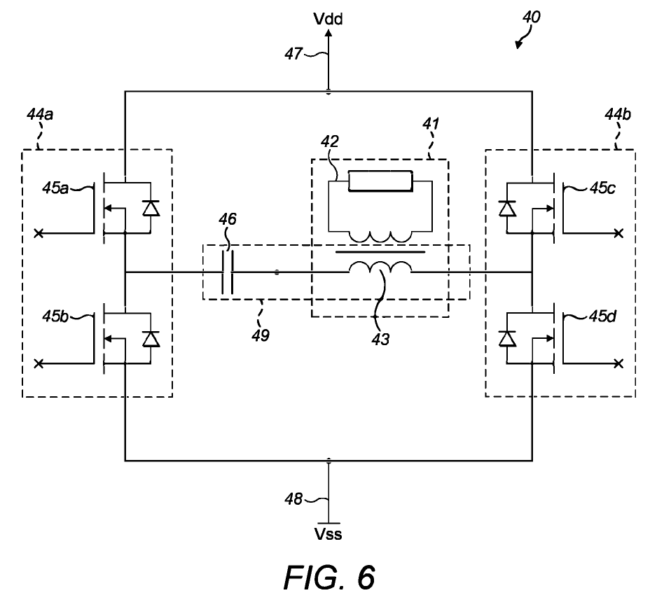

Example arrangements of the switching arrangement 13 and the resonant circuit 14 are discussed in greater detail below with respect to FIG. 6.

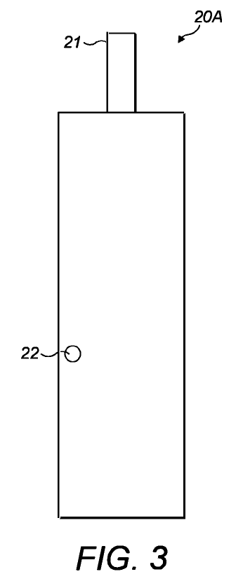

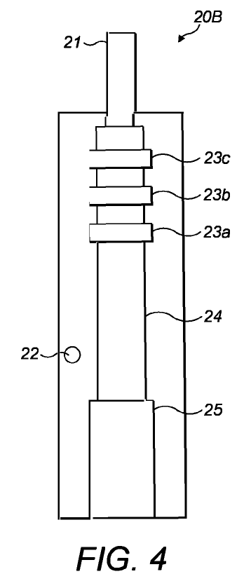

FIGS. 3 and 4 show a non-combustible aerosol generating device, indicated generally by the reference numeral 20, in accordance with an example embodiment. FIG. 3 is a perspective illustration of an aerosol generating device 20A with an outer cover. The aerosol generating device 20A may comprise a replaceable article 21 that may be inserted in the aerosol generating device 20A to enable heating of a susceptor comprised within the article 21 (or provided elsewhere). The aerosol generating device 20A may further comprise an activation switch 22 that may be used for switching on or switching off the aerosol generating device 20A. Further elements of the aerosol generating device 20 are illustrated in FIG. 4.

FIG. 4 depicts an aerosol generating device 20B with the outer cover removed. The aerosol generating device 20B comprises the article 21, the activation switch 22, a plurality of inductive elements 23a, 23b, and 23c, and one or more air tube extenders 24 and 25. The one or more air tube extenders 24 and 25 may be optional.

The plurality of inductive elements 23a, 23b, and 23c may each form part of a resonant circuit, such as the resonant circuit 14. The inductive element 23a may comprise a helical inductor coil. In one example, the helical inductor coil is made from Litz wire/cable which is wound in a helical fashion to provide the helical inductor coil. Many alternative inductor formations are possible, such as inductors formed within a printed circuit board. The inductive elements 23band 23cmay be similar to the inductive element 23a. The use of three inductive elements 23a, 23band 23c is not essential to all example embodiments. Thus, the aerosol generating device 20 may comprise one or more inductive elements.

A susceptor may be provided as part of the article 21. In an example embodiment, when the article 21 is inserted in aerosol generating device, the aerosol generating device 20 may be turned on due to the insertion of the article 21. This may be due to detecting the presence of the article 21 in the aerosol generating device using an appropriate sensor (e.g., a light sensor) or, in cases where the susceptor forms a part of the article 21, by detecting the presence of the susceptor using the resonant circuit 14, for example. When the aerosol generating device 20 is turned on, the inductive elements 23 may cause the article 21 to be inductively heated through the susceptor. In an alternative embodiment, the susceptor may be provided as part of the aerosol generating device 20 (e.g. as part of a holder for receiving the article 21).

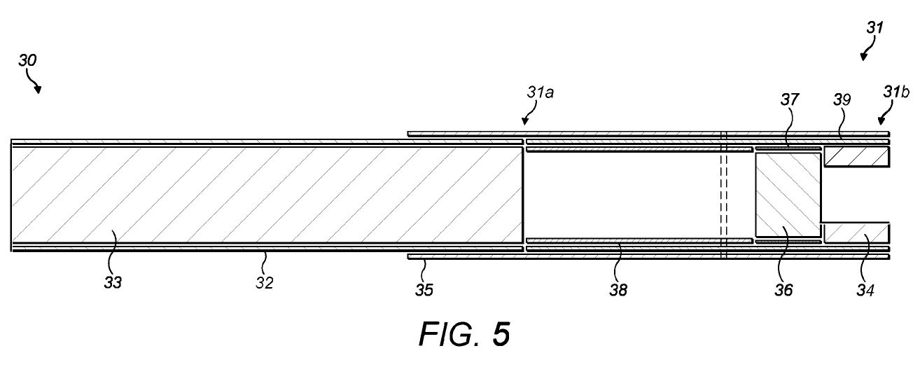

FIG. 5 is a view of an article, indicated generally by the reference numeral 30, for use with a non-combustible aerosol generating device in accordance with an example embodiment. The article 30 is an example of the replaceable article 21 described above with reference to FIGS. 3 and 4.

The article 30 comprises a mouthpiece 31, and a cylindrical rod of aerosol generating material 33, in the present case tobacco material, connected to the mouthpiece 31. The aerosol generating material 33 provides an aerosol when heated, for instance within a non-combustible aerosol generating device, such as the aerosol generating device 20, as described herein. The aerosol generating material 33 is wrapped in a wrapper 32. The wrapper 32 can, for instance, be a paper or paper-backed foil wrapper. The wrapper 32 may be substantially impermeable to air.

In one embodiment, the wrapper 32 comprises aluminum foil. Aluminum foil has been found to be particularly effective at enhancing the formation of aerosol within the aerosol generating material 33. In one example, the aluminum foil has a metal layer having a thickness of about 6 µm. The aluminum foil may have a paper backing. However, in alternative arrangements, the aluminum foil can have other thicknesses, for instance between 4 µm and 16 µm in thickness. The aluminum foil also need not have a paper backing, but could have a backing formed from other materials, for instance to help provide an appropriate tensile strength to the foil, or it could have no backing material. Metallic layers or foils other than aluminum can also be used. Moreover, it is not essential that such metallic layers are provided as part of the article 21; for example, such a metallic layer could be provided as part of the apparatus 20.

The aerosol generating material 33, also referred to herein as an aerosol generating substrate 33, comprises at least one aerosol forming material. In the present example, the aerosol forming material is glycerol. In alternative examples, the aerosol forming material can be another material as described herein or a combination thereof. The aerosol forming material has been found to improve the sensory performance of the article, by helping to transfer compounds such as flavor compounds from the aerosol generating material to the consumer.

As shown in FIG. 5, the mouthpiece 31 of the article 30 comprises an upstream end 31a adjacent to an aerosol generating substrate 33 and a downstream end 31b distal from the aerosol generating substrate 33. The aerosol generating substrate may comprise tobacco, although alternatives are possible.

The mouthpiece 31, in the present example, includes a body of material 36 upstream of a hollow tubular element 34, in this example adjacent to and in an abutting relationship with the hollow tubular element 34. The body of material 36 and hollow tubular element 34 each define a substantially cylindrical overall outer shape and share a common longitudinal axis. The body of material 36 is wrapped in a first plug wrap 37. The first plug wrap 37 may have a basis weight of less than 50 gsm, such as between about 20 gsm and 40 gsm.

In the present example the hollow tubular element 34 is a first hollow tubular element 34 and the mouthpiece includes a second hollow tubular element 38, also referred to as a cooling element, upstream of the first hollow tubular element 34. In the present example, the second hollow tubular element 38 is upstream of, adjacent to and in an abutting relationship with the body of material 36. The body of material 36 and second hollow tubular element 38 each define a substantially cylindrical overall outer shape and share a common longitudinal axis. The second hollow tubular element 38 is formed from a plurality of layers of paper which are parallel wound, with butted seams, to form the tubular element 38. In the present example, first and second paper layers are provided in a two-ply tube, although in other examples 3, 4 or more paper layers can be used forming 3, 4 or more ply tubes. Other constructions can be used, such as spirally wound layers of paper, cardboard tubes, tubes formed using a papier-mâché type process, molded or extruded plastic tubes or similar. The second hollow tubular element 38 can also be formed using a stiff plug wrap and/or tipping paper as the second plug wrap 39 and/or tipping paper 35 described herein, meaning that a separate tubular element is not required.

The second hollow tubular element 38 is located around and defines an air gap within the mouthpiece 31 which acts as a cooling segment. The air gap provides a chamber through which heated volatized components generated by the aerosol generating material 33 may flow. The second hollow tubular element 38 is hollow to provide a chamber for aerosol accumulation yet rigid enough to withstand axial compressive forces and bending moments that might arise during manufacture and whilst the article 21 is in use. The second hollow tubular element 38 provides a physical displacement between the aerosol generating material 33 and the body of material 36. The physical displacement provided by the second hollow tubular element 38 will provide a thermal gradient across the length of the second hollow tubular element 38.

Of course, the article 30 is provided by way of example only. The skilled person will be aware of many alternative arrangements of such an article that could be used in the systems described herein.

FIG. 6 is a block diagram of a circuit, indicated generally by the reference numeral 40, in accordance with an example embodiment. The circuit 40 comprises a positive terminal 47 and a negative (ground) terminal 48 (that are an example implementation of the DC voltage supply 11 of the system 10 described above). The circuit 40 comprises a switching arrangement 44 (implementing the switching arrangement 13 described above), where the switching arrangement 44 comprises a bridge circuit (e.g. an H-bridge circuit, such as an FET H-bridge circuit). The switching arrangement 44 comprises a first circuit branch 44a and a second circuit branch 44b, where the first circuit branch 44a and the second circuit branch 44b may be coupled by a resonant circuit 49 (implementing the resonant circuit 14 described above). The first circuit branch 44acomprises switches 45aand 45b, and the second circuit branch 44b comprises switches 45c and 45d. The switches 45a, 45b, 45c, and 45dmay be transistors, such as field-effect transistors (FETs), and may receive inputs from a controller, such as the processor 18 of the system 10. The resonant circuit 49 comprises a capacitor 46 and an inductive element 43 such that the resonant circuit 49 may be an LC resonant circuit. The circuit 40 further comprises a current sensor 50 (implementing the current sensor 15 described above) for measuring a current flowing through the inducting element 43. The circuit 40 further shows a susceptor equivalent circuit 42 (thereby implementing the susceptor arrangement 16). The susceptor equivalent circuit 42 comprises a resistance and an inductive element that indicate the electrical effect of an example susceptor arrangement 16. When a susceptor is present, the susceptor arrangement 42 and the inductive element 43 may act as a transformer 41. Transformer 41 may produce a varying magnetic field such that the susceptor is heated when the circuit 40 receives power. During a heating operation, in which the susceptor arrangement 16 is heated by the inductive arrangement, the switching arrangement 44 is driven (e.g., by control circuit 18) such that each of the first and second branches are coupled in turn such that an alternating current is passed through the resonant circuit 14. The resonant circuit 14 will have a resonant frequency, which is based in part on the susceptor arrangement 16, and the control circuit 18 may be configured to control the switching arrangement 44 to switch at the resonance frequency or a frequency close to the resonant frequency. Driving the switching circuit at or close to resonance helps improve efficiency and reduces the energy being lost to the switching elements (which causes unnecessary heating of the switching elements). In an example in which the article 21 comprising an aluminum foil is to be heated, the switching arrangement 44 may be driven at a frequency of around 2.5 MHz. However, in other implementations, the frequency may, for example, be anywhere between 500 kHz to 4 MHz.

A susceptor is a material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

In one embodiment, the susceptor is in the form of a closed circuit. It has been found in some embodiments that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

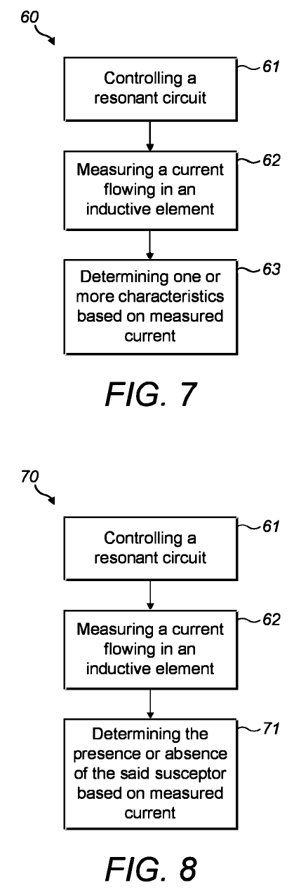

FIGS. 7 to 9 are flowcharts of algorithms, indicated generally by the reference numerals 60, 70 and 80 respectively, in accordance with example embodiments. FIGS. 7 to 9 may be viewed in conjunction with the previous figures(FIG. 2 in particular) for better understanding of the operations.

With respect to the algorithm 60 of FIG. 7, at operation 61, a resonant circuit of an aerosol generating device may be controlled, where the resonant circuit may comprise one or more inductive elements. The one or more inductive elements may be used for inductively heating a susceptor arrangement to heat an aerosol generating material. Heating the aerosol generating material may thereby generate an aerosol in a heating mode of operation of the aerosol generating device. For example, the resonant circuit 14 of the system 10 may be controlled by the processor 18. At operation 62, a current flowing in an inductive element is measured by a current sensor. For example, a current flowing in one or more inductive elements of the resonant circuit 14 may be measured by the current sensor 15. At operation 63, one or more characteristics of the aerosol generating device and/or an apparatus for the aerosol generating device may be determined based, at least in part, on the measured current.

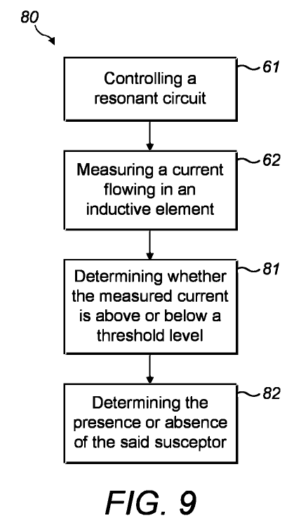

With respect to the algorithm 70 of FIG. 8, operations 61 and 62 are performed, similar to the operations 61 and 62 of algorithm 60 of FIG. 7. At operation 71 of the algorithm 70, a presence or absence of the susceptor arrangement, such as the susceptor arrangement 16, is determined by a processor, such as the processor 18, based on the measured current. In the event that there is no susceptor arrangement present (e.g. if there is no removable article present), then the resonant circuit sees a very low resistance, resulting in a high current flowing. Thus, the detection of a high current is indicative of the susceptor arrangement being absent. An example implementation of such an arrangement is described further below with respect to FIG. 9.

With respect to the algorithm 80 of FIG. 9, operations 61 and 62 are performed, similar to the operations 61 and 62 of algorithm 60 of FIG. 7. At operation 81 of the algorithm 80, it is determined whether the measured current is above or below a threshold level. At operation 82, a presence or absence of the susceptor arrangement, such as the susceptor arrangement 16, is determined by a processor, such as the processor 18, based on whether the measured current is above or below the threshold level. For example, if the measured current is above the threshold level, it may be determined that the susceptor arrangement is not present. If the measured current is below the threshold level, it may be determined that the susceptor arrangement is present in the aerosol generating device.

The one or more characteristics of the aerosol generating device and/or an apparatus for the aerosol generating device determined in the operation 63 may take many forms. As discussed further above, the said characteristics may include the presence or absence of a susceptor or a removable article. Alternatively, or in addition, the said characteristics may include one or more of the options discussed below.

The one or more characteristics determined in the operation 63 may include one or more fault conditions. The one or more fault conditions may be related to a faulty operation of the aerosol generating device. For example, the measured current level may indicate that one or more parts of the aerosol generating device may not be operating normally as expected, or may not be working at all. Other fault conditions may include information regarding whether the removable article is inserted in the aerosol generating device in a correct manner (such as being inserted the right way round and/or being fully inserted), whether the removable article is in a good condition, or the like. In general, the measured current is compared against an expected current value which is a value obtained or determined in the absence of any fault conditions or the like. The expected current value may be dependent on other parameters or operational states of the device (e.g., whether the device is to achieve one of a number of temperatures or powers supplied to the heating circuitry). The measured current value may be compared against a single expected current value and a decision made whether the measured value is greater than or less than the expected current value, or in other instances, the measured current value is compared to a range of expected current values and a decision made whether the measured current value lies within the range of expected current values.

The one or more characteristics determined in the operation 63 may include whether the measured current matches the current of a predefined susceptor arrangement (such as a genuine inserted article). For example, a predefined susceptor arrangement may include a genuine susceptor which is a part of a genuine article manufactured by a genuine and known manufacturer. For example, it may be preferred that the aerosol generating device is compatible with the inserted article, and the operation of the aerosol generating device may be optimal when a compatible genuine article is inserted. A current that flows in the inductive elements of the aerosol generating device when a genuine article is used, may be known as a threshold current level. In the operation 63, if the current matches the threshold current level, it may be determined that the inserted susceptor is similar to a predefined susceptor arrangement, and the article corresponding to the inserted susceptor is a compatible genuine article. If the current does not match with the threshold current level, it may be determined that the inserted susceptor is not similar to a predefined susceptor arrangement, and the article corresponding to the inserted susceptor is not a compatible genuine article. As above, the measured current value may be compared against a single expected current value and a decision made whether the measured value is greater than or less than the expected current value, or in other instances, the measured current value is compared to a range of expected current values and a decision made whether the measured current value lies within the range of expected current values.

The one or more characteristics determined in the operation 63 may include whether the measured current is consistent with the susceptor arrangement having a temperature above a first temperature threshold and/or below a second temperature threshold. For example, the aerosol generating device may comprise a temperature sensing arrangement for measuring a temperature of the susceptor or may include an impulse response based temperature measurement, as discussed in detail below. In one example, the temperature of the susceptor may be preferred to be above the first temperature threshold and/or below the second temperature threshold. When a susceptor is at relatively high temperature, the temperature sensor at the aerosol generating device may detect the high temperature. However, when the susceptor is removed (while being at a high temperature) from the aerosol generating device, the temperature sensor may not detect that the susceptor has been removed. This may be due to a number of factors depending on the specifics of how temperature is sensed. In some implementations, the temperature detected by the temperature sensor may still be high until the aerosol generating device cools down. In other implementations, the temperature sensor, or temperature sensor algorithm, such as the impulse response based temperature measurement, may not be able to distinguish between susceptors at a high temperature versus the absence of a susceptor. As discussed above, the current measurement may be used for determining the presence or absence of the susceptor. As such, the current measurement may be used for confirming whether the temperature sensor is accurately providing the temperature of the susceptor, or whether the susceptor has been removed, by determining whether the measured current is consistent with the susceptor having a temperature above the first temperature threshold and/or below the second temperature threshold. This may be beneficial as a safety mechanism, as the aerosol generating device may preferably be turned off, or a heating mode of the aerosol generating device may be turned off in the absence of a susceptor. That is, for example, the current sensor may be used to distinguish between a hot susceptor and an absent susceptor (which conditions may, in some circumstances, give similar impulse responses, such that these conditions are difficult to distinguish using only the temperature detection algorithm discussed in detail below).

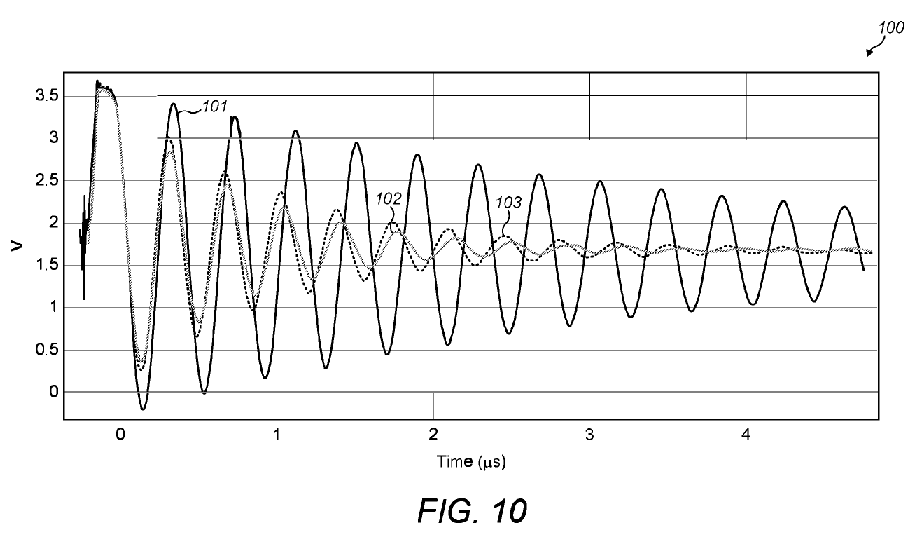

FIG. 10 shows plots, indicated generally by the reference numeral 100, demonstrating example uses of example embodiments. The plots 100 show current sensor output plotted against time (in microseconds). The plots 100 include a first plot 101 in which the susceptor was absent, a second plot 102 in which the susceptor was relatively hot and a third plot 103 in which the susceptor was relatively cold.

The plots clearly show that, in this example, in the absence of a susceptor, the current sensor output is larger and the oscillations continue for much longer. The current sensor outputs when the susceptor is hot and cold in this example are similar. Accordingly, the current sensor output can be used to provide information about the susceptor.

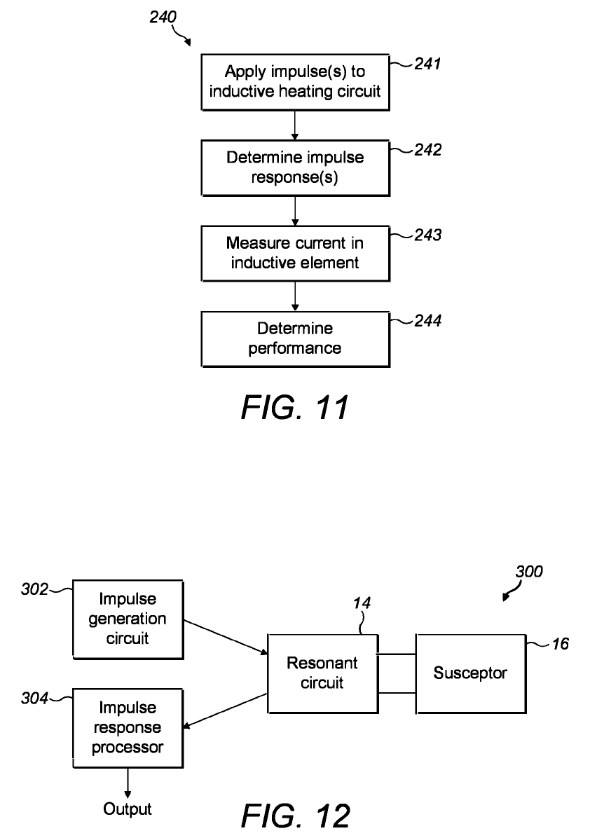

FIG. 11 is a flow chart showing an algorithm, indicated generally by the reference numeral 240, in accordance with an example embodiment.

The algorithm 240 starts at operation 241, where one or more impulses are applied to an inductive heating circuit (such as the resonant circuit 14 of the system 10 described above). At operation 242, impulse response(s) are determined (as discussed further below). At operation 243, a current flowing in the inductive element is measured (e.g. using the current sensor 15). At operation 244, one or more performance characteristics of the relevant system, are determined based on said measured current.

FIG. 12 is a block diagram of a system, indicated generally by the reference numeral 300, in accordance with an example embodiment. The system 300 comprises the resonant circuit 14 and the susceptor 16 of the system 10 described above. The system 300 further comprises an impulse generation circuit 302 and an impulse response processor 304. The impulse generation circuit 302 and the impulse response processor 304 may be implemented as part of the control circuit 18 of the system 10 and may implement the operations 241 and 242 of the algorithm 240 described above.

The impulse generation circuit 302 may be implemented using a first switching arrangement (such as an H-bridge circuit) to generate the impulse by switching between positive and negative voltage sources. For example, the switching arrangement 44 described above with reference to FIG. 6 may be used. As described further below, the impulse generation circuit 302 may generate an impulse by changing the switching states of the FETs of the switching arrangement 44 from a condition where the switches 45b and 45d are both on (such that the switching arrangement is grounded) and the switches 45a and 45b are off, to a state where the switch states of one of the first and second circuit branches 44a and 44b are reversed. The impulse generation circuit 302 may alternatively be provided using a pulse width modulation (PWM) circuit. Other impulse generation arrangements are also possible.

The impulse response processor 304 may determine one or more performance metrics (or characteristics) of the resonant circuit 14 and the susceptor 16 based on the impulse response. Such performance metrics include properties of an article (such as the removable article 21), presence or absence of such an article, type of article, temperature of operation etc.

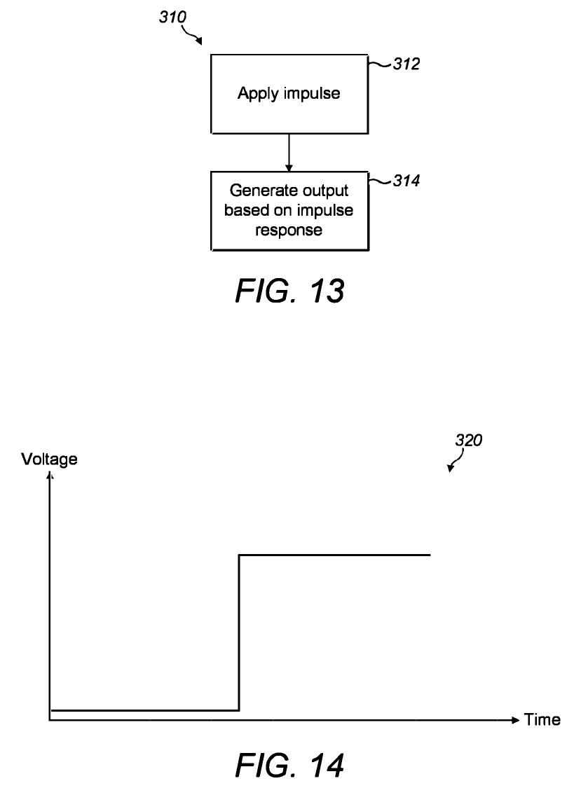

FIG. 13 is a flow chart showing an algorithm, indicated generally by the reference numeral 310, in accordance with an example embodiment. The algorithm 310 shows an example use of the system 300.

The algorithm 310 starts at operation 312 where an impulse (generated by the impulse generation circuit 302) is applied to the resonant circuit 14. FIG. 14 is a plot, indicated generally by the reference numeral 320, showing an example impulse that might be applied in the operation 312.

The impulse may be applied to the resonant circuit 14. Alternatively, in systems having multiple inductive elements (such as non-combustible aerosol arrangement 20 described above with reference to FIGS. 3 and 4), the impulse generation circuit 302 may select one of a plurality of resonant circuits, each resonant circuit comprising an inductive element for inductively heating a susceptor and a capacitor, wherein the applied impulse induces an impulse response between the capacitor and the inductive element of the selected resonant circuit.

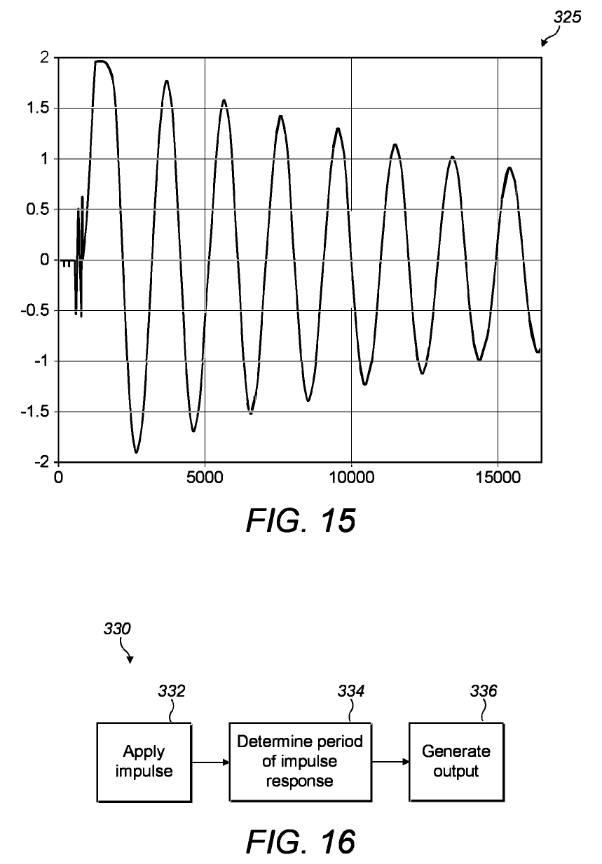

At operation 314, an output is generated (by the impulse response processor 304) based on an impulse response that is generated in response to the impulse applied in operation 312. FIG. 15 is a plot, indicated generally by the reference numeral 325, showing an example impulse response that might be received at the impulse response processor 304 is response to the impulse 320. As shown in FIG. 15, the impulse response may take the form of a ringing resonance. The impulse response is a result of charge bouncing between the inductor(s) and capacitor of the resonant circuit 14. In one arrangement, no heating of the susceptor is caused as a result. That is, the temperature of the susceptor remains substantially constant (e.g.., within ±1°C or ±0.1°C of the temperature prior to applying the impulse).

At least some of the properties of the impulse response (such as frequency and/or decay rate of the impulse response) provide information regarding the system to which the impulse is applied. Thus, as discussed further below, the system 300 can be used to determine one or more properties of the system to which the impulse is applied. For example one or more performance properties, such as fault conditions, properties of an inserted article 21, presence or absence of such an article, whether the article 21 is genuine, temperature of operation etc., can be determined based on output signal derived from an impulse response. The system 300 may use the determined one or more properties of the system to perform further actions (or prevent further actions if so desired) using the system 10, for example, to perform heating of the susceptor arrangement 16. For instance, based on the determined temperature of operation, the system 300 can choose what level of power is to be supplied to the induction arrangement to cause further heating of the susceptor arrangement, or whether power should be supplied at all. For some performance properties, such as fault conditions or determining whether the article 21 is genuine, a measured property of the system (as measured using the impulse response) can be compared to an expected value or range of values for the property, and actions taken by the system 300 are performed on the basis of the comparison.

FIG. 16 is a flow chart showing an algorithm, indicated generally by the reference numeral 330, in accordance with an example embodiment. At operation 332 of the algorithm 330, an impulse is applied to the resonant circuit 14 by the impulse generation circuit 302. Thus, the operation 332 is the same as the operation 312 described above.

At operation 334 of the algorithm 330, a period of an impulse response induced in response to the applied impulse is determined by the impulse response processor 304. Finally, at operation 336, an output is generated (based on the determined period of the impulse response).

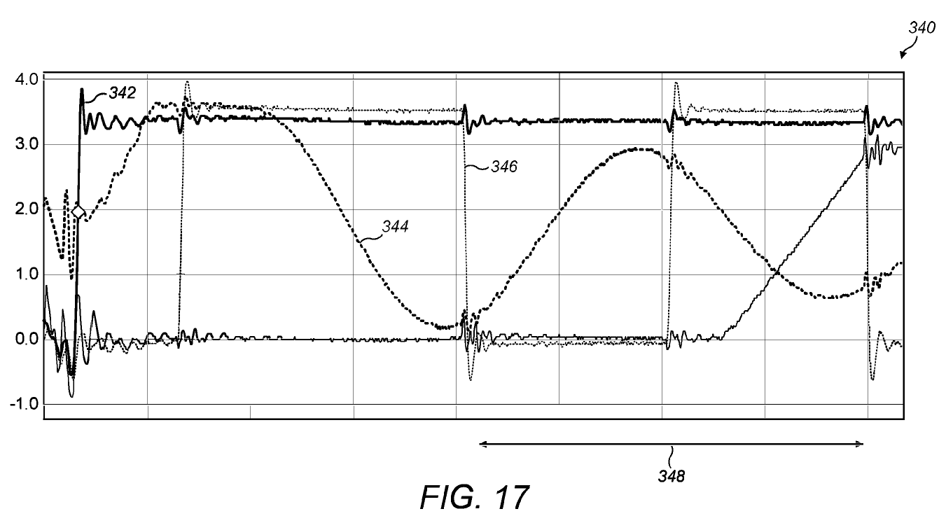

FIG. 17 is a plot, indicated generally by the reference numeral 340, showing an example use of the algorithm 330. The plot 340 shows an impulse 342 applied to the resonant circuit 14 by the impulse generation circuit 302. The application of the impulse 342 implements the operation 332 of the algorithm 330. An impulse response 344 is induced in response to the applied impulse. The impulse 342 may be held in its final state (high in the plot 340) for the duration of the measurement, but this is not essential. For example, a high-low impulse could be applied (and then held low).

The impulse response processor 304 generates a signal 346 indicating edges of the impulse response 334. As discussed further below, the signal 346 may be generated by a comparator and there may be a delay between the occurrence of the edge and the generation of the signal. If consistent, that delay may not be significant to the processing.

At operation 334 of the algorithm 330, a period of the impulse response is determined. An example period is indicated by the arrow 348 in FIG. 17.

At operation 336 of the algorithm 330, an output is generated based on the determined period 348. Thus, the output signal is based on a time period from a first edge of the impulse and a second edge that is one complete cycle of said impulse response later. The output signal is therefore dependent on a time period of voltage oscillations of the impulse response, such that the output signal is indicative of the resonant frequency of the impulse response.

In some embodiments, the period 348 is temperature dependent. Accordingly, the output generated in operation 336 may be a temperature estimate.

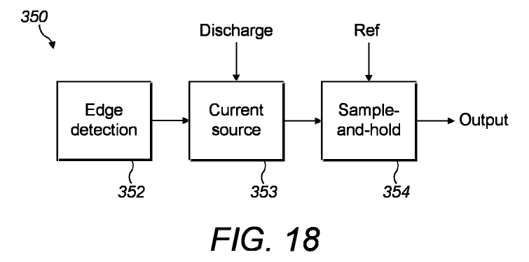

FIG. 18 is a block diagram of a system, indicated generally by the reference numeral 350, in accordance with example embodiments. The system 350 may be used to implement the operations 336 of the algorithm 330 described above.

The system 350 comprises an edge detection circuit 352, a current source 353 and a sample-and-hold circuit 354.

The edge detection circuit 352 can be used to determine edges of signals, such as the impulse response signals 344 described above. Accordingly, the edge detection circuit 352 may generate the signals 346 described above. The edge detection circuit 352 may, for example, be implemented using a comparator or some similar circuit.

The edge detection circuit 352 provides an enable signal to the current source 353. Once enabled, the current source can be used to generate an output (such as a voltage output across a capacitor). The current source has a discharge input that acts as a reset input. The current source output can be used to indicate a time duration since an output of edge detection circuit 352 enabled the current source. Thus, the current source output can be used as an indication of time duration (e.g. pulse duration).

The sample-and-hold circuit 354 can be used to generate an output signal based on the output of the current source 353 at a particular time. The sample-and-hold circuit may have a reference input. The sample-and-hold circuit can be used as an analog-to-digital converter (ADC) that converts a capacitor voltage into a digital output. In other systems, any other suitable electronic components, such as a voltmeter, may be used to measure the voltage.

The system 350 may be implemented using a charge time measurement unit (CTMU), such as an integrated CTMU.

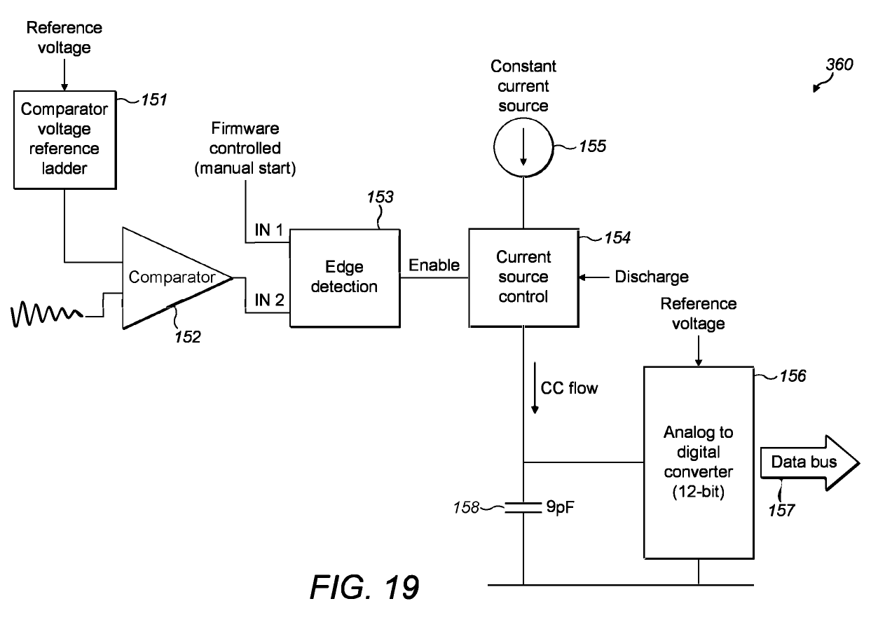

FIG. 19 is a block diagram of a system, indicated generally by the reference numeral 360, in accordance with example embodiments. The system 360 shows features of a CTMU that may be used in example embodiments.

The system 360 comprises a reference voltage generator 151, a comparator 152, an edge detection module 153, a current source controller 154, a constant current source 155, an analog-to-digital converter 156 providing a data output 157 to a data bus, and an external capacitor 158. As discussed further below, the voltage generator 151, the comparator 152 and the edge detection module 153 may be used to implement the edge detection circuit 352 described above, the current source controller 154 and the constant current source 155 may be used to implement the current source 353 described above, and the analog-to-digital converter 156 may be used to implement the sample-and-hold circuit 354 described above.

The impulse response generated in the operations 314 and 334 described above is provided to an input of the comparator 152, where the impulse response is compared with the output of the reference voltage generator 151. The comparator may output a logical high signal when the impulse response is greater than the reference voltage and a logical low signal when the impulse response is less than the reference voltage (or vice versa). The output of the comparator is fed into an input (IN2) of the edge detection circuit 153. The other input of the edge detection circuit 153 (IN1) is a firmware controlled input. The edge detection circuit 153 (which may simply be a selectable RS flip-flop) generates an enable signal dependent on the identification of edges at the output of the comparator 152. The edge detection circuit 153 may be programmable such that the nature of edges that are being detected (e.g. rising or falling edges, first edges etc.) can be indicated.

The enable signal is provided as an input to the current source controller 154. When enabled, that current source controller applies a current (from the constant current source 155) that is used to charge the external capacitor 158. The discharge input to the current source controller can be used to discharge the external capacitor 158 (and effectively reset the stored charge on the capacitor to a baseline value).

The analog-to-digital converter 156 is used to determine the voltage across the external capacitor 158, which voltage is used to provide the data output 157. In this way, the system 150 provides a voltage ramp that is initialized on an identified edge and ends when a second edge is identified.

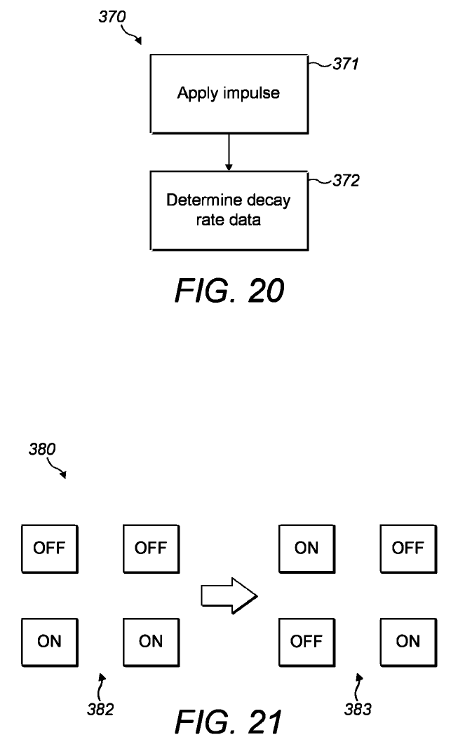

There are many other example uses of the systems described herein. By way of example, FIG. 20 is a flow chart showing an algorithm, indicated generally by the reference numeral 370, in accordance with an example embodiment. The algorithm 370 starts at operation 371 where an impulse is generated and applied to the resonant circuit 14. At operation 372, a decay rate of the impulse response induced in response to the applied impulse is determined. The decay rate may, for example, be used to determine information regarding the circuit to which the impulse is applied. By way of example, a decay rate in the form of a Q-factor measurement may be used to estimate a temperature of operation. The operation 372 is an example of the operation 214 in FIG. 13. That is, the decay rate is an example of an output based on the impulse response.

FIG. 21 is a block diagram of a circuit switching arrangement, indicated generally by the reference numeral 380, in accordance with an example embodiment. The switching arrangement 380 shows switch positions of the circuit 40 in a first state, indicated generally by the reference numeral 382, and a second state, indicated generally by the reference numeral 383.

In the first state 382, the switches 45a and 45c of the circuit 40 are off (i.e. open) and the switches 45band 45dare on (i.e. closed). In the second state 383, the switches 45aand 45dare on (i.e. closed) and the switches 45band 45care off. Thus, in the first state 382, both sides of the resonant circuit 49 are connected to ground. In the second state 383, a voltage pulse is applied to the resonant circuit.

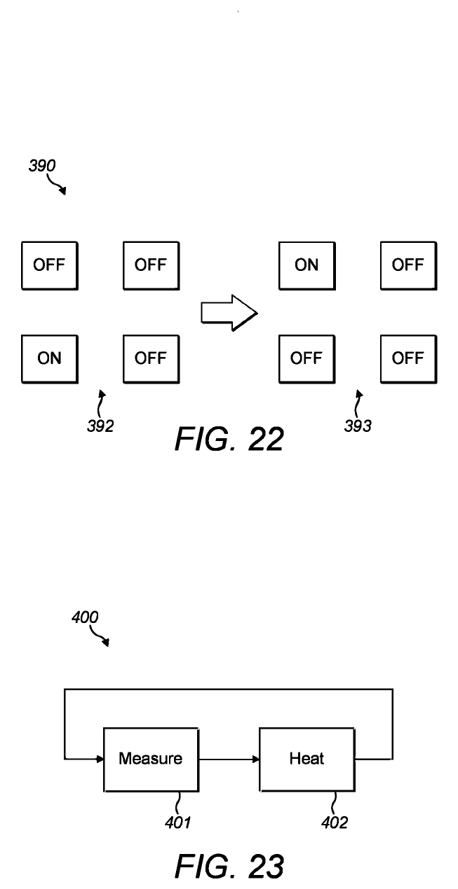

FIG. 22 is a block diagram of a circuit switching arrangement, indicated generally by the reference numeral 390, in accordance with an example embodiment. The switching arrangement 390 shows switch positions of the circuit 40 in a first state, indicated generally by the reference numeral 392, and a second state, indicated generally by the reference numeral 393.

In the first state 392, the switch 45b is on (i.e. closed) and the switches 45a, 45cand 45dare off (i.e. open). Thus, one side of the resonant circuit 49 is grounded. In the second state 393, a voltage pulse (i.e. an impulse) is applied to the resonant circuit.

In the second state 382 of the switching arrangement 380, a current is able to flow through the first switch 45a, the resonant circuit 49 and the switch 45d. This current flow may lead to heat generation and discharging of a power supply (such as a battery). Conversely, in the second state 393 of the switching arrangement 390, a current will not flow through the switch 45d. Accordingly, heat generation and power supply discharge may be reduced. Moreover, noise generation may be reduced on the generation of each impulse.

FIG. 23 is a flow chart, indicated generally by the reference numeral 400, showing an algorithm in accordance with an example embodiment. The algorithm 400 shows an example use of the systems described herein.

The algorithm 400 starts with a measurement operation 401. The measurement operation 401 may, for example, include a temperature measurement. Next, at operation 402, a heating operation is carried out. The implementation of the heating operation 402 may be dependent on the output of the measurement operation 401. Once the heating operation 402 is complete, the algorithm 400 returns to operation 401, where the measurement operation is repeated.

The operation 401 may be implemented by the system 300 in which an impulse is applied by the impulse generation circuit 302 and a measurement (e.g. a temperature measurement) determined based on the output of the impulse response processor 304. As discussed above, a temperature measurement may be based, for example, on a decay rate, an impulse response time, an impulse response period etc.

The operation 402 may be implemented by controlling the circuit 40 is order to heat the susceptor 16 of the system 10. The inductive heating arrangement 12 may be driven at or close to the resonant frequency of the resonant circuit, in order to cause an efficient heating process. The resonant frequency may be determined based on the output of the operation 401.

In one implementation of the algorithm 400, the measurement operation is conducted for a first period of time, the heating operation 402 is conducted for a second period of time and the process is then repeated. For example, the first period of time may be 10ms and the second period of time may be 250ms, although other time periods are possible. In other words, the measurement operation may be performed between successive heating operations. It should also be noted that the heating operation 402 being conducted for the second period of time does not necessarily imply that power is supplied to the induction coil for the whole duration of the second period of time. For example, power may only be supplied for a fraction of the second period of time.

In an alternative embodiment, the algorithm 400 may be implemented with the heating operation 402 having a duration dependent on a required level of heating (with the heating duration being increased if more heating is required and reduced if less heating is required). In such an algorithm, the measurement operation 401 may simply be carried out when heating is not being conducted, such that the heating operation 402 need not be interrupted in order to conduct the measurement operation 401. This interleaved heating arrangement may be referred to as a pulse-width-modulation approach to heating control. By way of example, a pulse-width modulation scheme may be provided at a frequency of the order of 100Hz, where each period is divided into a heating portion (of variable length) and a measurement portion.

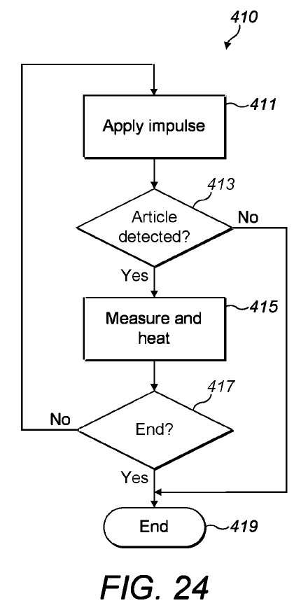

FIG. 24 is a flow chart, indicated generally by the reference numeral 410, showing an algorithm in accordance with an example embodiment. The algorithm 410 may be implemented using the system 300 described above.

The algorithm 410 starts at operation 411, where an impulse is applied to the resonant circuit 14 by the switching circuit 13 (e.g. the circuit 40). At operation 413, an impulse response (e.g. detected using the impulse response processor 304) is used to determine whether an article (such as the article 21) is present in the system to be heated. As discussed above, the presence of the article 21 affects the impulse response in a manner that can be detected.

If an article is detected at operation 413, the algorithm 410 moves to operation 415; otherwise, the algorithm terminates at operation 419.

At operation 415, measurement and heating operations are implemented. By way of example, the operation 415 may be implemented using the algorithm 400 described above. Of course, alternative measurement and heating arrangements could be provided.

Once a number of heating measurement and heating cycles have been conducted, the algorithm 400 moves to operation 417, where it is determined whether heating should be stopped (e.g. if a heating period has expired, or in response to a user input). If so, the algorithm terminates at operation 419; otherwise the algorithm 400 returns to operation 411.

It should be appreciated that the above techniques for determining one or more properties of the inductive arrangement or susceptor arrangement can be applied to individual inductive elements. For systems that comprise multiple inductive elements, such as the system 20, which comprises three inductive elements 23a, 23b, and 23c, the system may be configured such that the one or more parameters, such as the temperature, can be determined for each of the inductive elements using the above described techniques. In some implementations, it may be beneficial for the system to operate using separate measurements for each of the inductive elements. In other implementations, it may be beneficial for the system to operate using only a single measurement for the plurality of inductive elements (e.g., in the case of determining whether the article 21 is present or not). In such situations, the system may be configured to determine an average measurement corresponding to the measurements obtained from each inductive element. In other instances, only one of the plurality of inductive elements may be used to determine the one or more properties.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure as defined by the claims or limitations on equivalents to the claims, and that other embodiments may be utilized and modifications may be made without departing from the scope of the claimed invention. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

What is claimed is:

1. An apparatus for an aerosol generating device, the apparatus comprising:
a resonant circuit comprising an inductive element for inductively heating a susceptor arrangement to heat an aerosol generating material to thereby generate an aerosol in a heating mode of operation;
a current sensor for measuring a current flowing in the inductive element; and
a processor for determining one or more characteristics of one or more of the aerosol generating device the apparatus and the susceptor arrangement based on said measured current, wherein the one or more characteristics determined by the processor include the presence or absence of the said susceptor arrangement.

2. The apparatus of claim 1, wherein the susceptor arrangement is provided as part of a removable article.

3. The apparatus of claim 2, wherein the one or more characteristics determined by the processor include properties of said removable article.

4. The apparatus of claim 3, wherein the properties of the removable article determined by the processor include the presence or absence of the said removable article.

5. The apparatus of claim 1, the one or more characteristics determined by the processor include one or more fault conditions.

6. The apparatus of claim 1, wherein the one or more characteristics determined by the processor include determining whether the current matches the current of a predefined susceptor arrangement.

7. The apparatus of claim 1, wherein determining said one or more characteristics includes determining whether current is consistent with the susceptor arrangement having a temperature above a first temperature threshold and/or below a second temperature threshold.

8. The apparatus of claim 1, further comprising a first switching arrangement for enabling an alternating current to be generated from a DC voltage supply and flow through the inductive element to cause inductive heating of the susceptor arrangement in the heating mode of operation.

9. The apparatus of claim 8, wherein the first switching arrangement comprises an H-bridge circuit.

10. The apparatus of claim 1, wherein the resonant circuit is an LC resonant circuit.

11. The apparatus of claim 1, further comprising:
an impulse generation circuit for applying an impulse to the resonant circuit, wherein the applied impulse induces an impulse response between a capacitor and the inductive element of the resonant circuit, wherein the impulse response has a resonant frequency; and
an output circuit for providing an output signal dependent on one or more properties of the impulse response.

12. The apparatus of claim 11, wherein the output signal is indicative of the resonant frequency of the pulse response.

13. The apparatus of claim 11, wherein the output signal is used to provide a temperature measurement of said inductive element.

14. The non-combustible aerosol generating device comprising the apparatus of claim 1.

15. The non-combustible aerosol generating device of claim 14, wherein the aerosol generating device is configured to receive a removable article comprising an aerosol generating material.

16. The non-combustible aerosol generating device of claim 15, wherein said aerosol generating material comprises an aerosol generating substrate and an aerosol forming material.

17. The non-combustible aerosol generating device of claim 15, wherein said removable article includes said susceptor arrangement.

18. A method comprising:
controlling a resonant circuit of an aerosol generating device, the resonant circuit comprising an inductive element for inductively heating a susceptor arrangement to heat an aerosol generating material to thereby generate an aerosol in a heating mode of operation;
measuring a current flowing in the inductive element; and
determining one or more characteristics of the aerosol generating device and/or the susceptor arrangement based on said measured current, wherein the one or more characteristics determined by the processor include the presence or absence of the said susceptor arrangement.

19. The method of claim 18, wherein the one or more characteristics determined by the processor include one or more of:
the presence or absence of the said susceptor arrangement;
properties of said removable article;
the presence or absence of the said removable article;
one or more fault conditions;
whether the current matches the current of a predefined susceptor arrangement;
whether current is consistent with the susceptor having a temperature above a first temperature threshold and/or below a second temperature threshold; or
whether the current matches the current of a genuine susceptor.

20. The method of claim 18, further comprising:
applying an impulse to the resonant circuit, wherein the applied impulse induces an impulse response between a capacitor and the inductive element of the resonant circuit, wherein the impulse response has a resonant frequency; and
generating an output signal dependent on one or more properties of the impulse response.

21. A kit of parts comprising an article for use in a non-combustible aerosol generating system, wherein the non-combustible aerosol generating system comprises the apparatus of claim 1.

22. The kit of parts of claim 21, wherein the article is a removable article comprising an aerosol generating material.

23. A computer program comprising instructions for causing an apparatus to perform at least the following:
control a resonant circuit of an aerosol generating device, the resonant circuit comprising an inductive element for inductively heating a susceptor arrangement to heat an aerosol generating material to thereby generate an aerosol in a heating mode of operation;
measure a current flowing in the inductive element; and
determine one or more characteristics of the aerosol generating device and/or the susceptor arrangement based on said measured current, wherein the one or more characteristics determined by the processor include the presence or absence of the said susceptor arrangement.
